(19) United States
(12) Patent Application Publication
(10) Pub. No.: US 2024/0251044 A1
(43) Pub. Date: Jul. 25, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Taiga KOKUBO, Kanagawa (JP)

(73) Assignee: FUJIFILM Business Innovation Corp., Tokyo (JP)

(21) Appl. No.: 18/362,235

(22) Filed: Jul. 31, 2023

(30) Foreign Application Priority Data
Jan. 24, 2023 (JP) 2023-009002

(51) Int. Cl. H04N 1/00; H04N 1/44

(52) U.S. Cl. CPC H04N 1/00514; H04N 1/00413; H04N 1/00474; H04N 1/00506; H04N 1/00517; H04N 1/4433

(57) ABSTRACT

An information processing apparatus includes a processor configured to: detect a type of a user who uses an application; and based on the type that has been detected, control whether to display or hide an instruction section for the application when a selection screen for the application is displayed, the instruction section being used to instruct that information regarding functionality of the application be displayed.

### CROSS-REFERENCE TO RELATED APPLICATIONS

This application is based on and claims priority under 35 USC 119 from Japanese Patent Application No. 2023-009002 filed Jan. 24, 2023.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2009-232428 discloses an electronic apparatus including a storage unit configured to sequentially record the frequency of use of each of the various settings or functions of an application program; a selecting unit configured to select a setting or a function whose frequency of use is equal to a predetermined value or less based on the frequency of use of each setting or function; and a display unit configured to display a description of the selected setting or function.

### SUMMARY

When the frequency of use of a setting or a function of an application is equal to a predetermined value or less, information may be displayed with regard to the functionality of the application, such as a description of a setting or a function of the application, but some users need no information regarding the functionality even if the frequency of use of such setting or function is small. In such a case, information unnecessary for those users is displayed. For example, a user who is a machine administrator has a good grasp of the functionality and has no need for the display of information regarding the functionality irrespective of the frequency of use, and such unnecessary information displayed in the screen results in a complicated screen, which is difficult to comprehend.

Thus, aspects of non-limiting embodiments of the present disclosure relate to providing an information processing apparatus, an information processing method, and a non-transitory computer readable medium that render a display easier to comprehend than an inflexible display in which information regarding the functionality of an application is permanently presented.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: detect a type of a user who uses an application; and based on the type that has been detected, control whether to display or hide an instruction section for the application when a selection screen for the application is displayed, the instruction section being used to instruct that information regarding functionality of the application be displayed.

### BRIEF DESCRIPTION OF THE DRAWINGS

An exemplary embodiment of the present disclosure will be described in detail based on the following figures, wherein:

FIG. 1 is an illustration depicting a schematic configuration of an information processing system according to the present exemplary embodiment;

FIG. 2 is a block diagram depicting a central portion of the electrical system of an image forming apparatus in the information processing system according to the present exemplary embodiment;

FIG. 3 is a block diagram depicting a central portion of the electrical system of each of a client computer and a mobile terminal apparatus in the information processing system according to the present exemplary embodiment;

FIG. 4 is an illustration depicting an example of a screen displaying an application list;

FIG. 5 is an illustration depicting an example of a screen displaying an application list in which, for each application, the links to video instructions on how to use the application and to a description of the function of the application are hidden;

FIG. 6 is an illustration depicting an example of a screen displaying an application list in which, for the applications “Send Email” and “Print”, the links to video instructions on how to use the application and to a description of the function of the application are hidden;

FIG. 7 is a functional block diagram depicting the functional configuration of the control unit of the image forming apparatus according to the present exemplary embodiment;

FIG. 8 is a flowchart depicting an example of a process performed by the image forming apparatus in the information processing system according to the present exemplary embodiment;

FIG. 9 is a flowchart depicting an example of a process of resuming the display of the links to the instructions on how to use an application and to the description of the function of an application in the image forming apparatus according to the present exemplary embodiment; and

FIG. 10 is an illustration depicting an example in which the entire row for an application is rendered a selectable area instead of placing a setting button.

### DETAILED DESCRIPTION

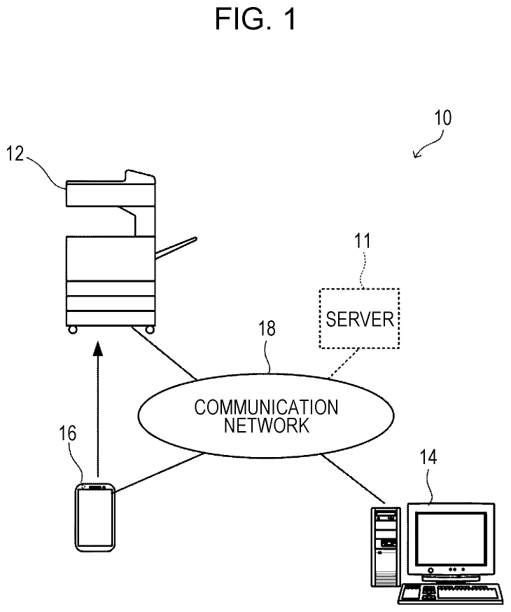

Hereinafter, an example according to the present exemplary embodiment will be described in detail with reference to the drawings. In the present exemplary embodiment, description will be given as an example with regard to an information processing system in which apparatuses including an image forming apparatus as an example of an information processing apparatus, a client computer, and a mobile terminal apparatus are connected to each other by using a communication network including various kinds of networks. FIG. 1 is an illustration depicting a schematic configuration of an information processing system 10 according to the present exemplary embodiment.

The information processing system 10 according to the present exemplary embodiment includes an image forming apparatus 12, a client computer 14, a mobile terminal apparatus 16, and other apparatuses as depicted in FIG. 1. The image forming apparatus 12 and the client computer 14 are connected to each other by using a communication network 18, such as a local area network (LAN), a wide area network (WAN), the Internet, or an intranet. The image forming apparatus 12, the client computer 14, and the mobile terminal apparatus 16 are capable of transmitting and receiving various kinds of data to and from each other via the communication network 18. In the present exemplary embodiment, the client computer 14 and the mobile terminal apparatus 16 are each configured to provide instructions for printing to the image forming apparatus 12, and the image forming apparatus 12 is configured to form an image according to the instructions. Although a single machine is depicted to represent each of the image forming apparatus 12, the client computer 14, and the mobile terminal apparatus 16 in FIG. 1, multiple machines may be used as each or one of these apparatuses. In addition, in the information processing system 10 according to the present exemplary embodiment, instructions for printing may be provided from the mobile terminal apparatus 16 not only via the communication network 18 but also via a near-field wireless communication such as Wi-Fi (registered trademark) or Bluetooth (registered trademark). As indicated by the dotted line in FIG. 1, a server 11 may further be included, and at least one of the client computer 14 and the mobile terminal apparatus 16 may be configured to send a request for image formation to the image forming apparatus 12 via the server 11.

The image forming apparatus 12 according to the present exemplary embodiment has multiple functions including an image forming function of receiving various kinds of data from the client computer 14 or the mobile terminal apparatus 16 and performing image forming processing based on received data; a reading function of scanning a document and obtaining image information representing the document; a copying function of copying an image recorded in a document onto a sheet of paper; a facsimile function of transmitting and receiving various kinds of data via a telephone line that is not depicted; a transfer function of transferring document information such as image information obtained by scanning, for example, by the reading function; and a storage function of storing document information such as image information obtained by scanning. The image forming apparatus 12 may have all or two or more of the functions described above.

In the following description, the facsimile function may be referred to as fax, the reading function may be referred to as scan, the image forming function may be referred to as print, and the copying function may be referred to as copy.

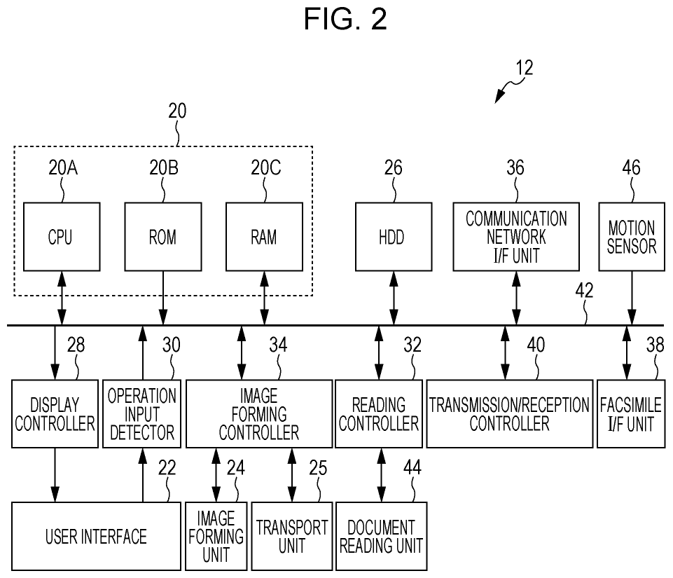

FIG. 2 is a block diagram depicting a central portion of the electrical system of the image forming apparatus 12 in the information processing system 10 according to the present exemplary embodiment.

The image forming apparatus 12 according to the present exemplary embodiment includes a control unit 20 in which a central processing unit (CPU) 20A, a read only memory (ROM) 20B, and a random access memory (RAM) 20C are included as depicted in FIG. 2. The CPU 20A is configured to manage the overall operation of the image forming apparatus 12. The RAM 20C is a memory such as used as a work area while the CPU 20A executes various programs. The ROM 20B is configured to store various control programs including an application program, various parameters, and other data in advance. In the image forming apparatus 12, the components in the control unit 20 are electrically connected to each other by using a system bus 42.

The image forming apparatus 12 according to the present exemplary embodiment includes a hard disk drive (HDD) 26 in which to store various kinds of data, an application program, and other programs. The image forming apparatus 12 also includes a display controller 28 that is connected to a user interface 22 and that is configured to control display of various operation screens and other screens on the display of the user interface 22. The image forming apparatus 12 also includes an operation input detector 30 that is connected to the user interface 22 and that is configured to detect operation instructions that is received by the user interface 22. In the image forming apparatus 12, the HDD 26, the display controller 28, and the operation input detector 30 are electrically connected to the system bus 42. Although the HDD 26 is used as a storage device in the image forming apparatus 12 according to the present exemplary embodiment, this is not meant to be limiting, and a nonvolatile storage device, such as a flash memory, may be used. In the present exemplary embodiment, although a touch panel, which is capable of displaying information and receiving operation input, is used as the user interface 22, this is not meant to be limiting, and a user interface including a display and an operation unit separately may be used.

The image forming apparatus 12 according to the present exemplary embodiment includes a reading controller 32 and an image forming controller 34, the reading controller 32 is configured to control optical image-reading operation by a document reading unit 44 and document transport operation by a document transport unit, and the image forming controller 34 is configured to control image forming processing by an image forming unit 24 and sheet transport to the image forming unit 24 by a transport unit 25. The image forming apparatus 12 includes a communication network interface (I/F) unit 36 that is connected to the communication network 18 and that is configured to transmit and receive communication data to and from other external devices, such as the client computer 14, which are connected to the communication network 18. The image forming apparatus 12 includes a facsimile interface (I/F) unit 38 that is connected to a telephone line not depicted and that is configured to transmit and receive facsimile data to and from a facsimile device connected to the telephone line. The image forming apparatus 12 includes a transmission/reception controller 40 configured to control transmission and reception of facsimile data via the facsimile I/F unit 38. The image forming apparatus 12 includes a motion sensor 46 configured to detect a person around the apparatus. In the image forming apparatus 12, the transmission/reception controller 40, the reading controller 32, the image forming controller 34, the communication network I/F unit 36, the facsimile I/F unit 38, and the motion sensor 46 are electrically connected to the system bus 42.

The above configuration enables the CPU 20A to access the RAM 20C, the ROM 20B, and the HDD 26 in the image forming apparatus 12 according to the present exemplary embodiment. The CPU 20A is configured to use the display controller 28 to control the display of an operation screen and the display of information such as various messages on a display screen of the user interface 22 in the image forming apparatus 12. The CPU 20A is configured to use the reading controller 32 to control the operation of the document reading unit 44 and the operation of the document transport unit in the image forming apparatus 12. The CPU 20A is configured to use the image forming controller 34 to control the operation of the image forming unit 24 and the operation of the transport unit 25 and is configured to use the communication network I/F unit 36 to control the transmission and reception of communication data in the image forming apparatus 12. The CPU 20A is configured to use the transmission/reception controller 40 to control the transmission and reception of facsimile data by the facsimile I/F unit 38 in the image forming apparatus 12. The CPU 20A is configured to obtain details of operation performed on the user interface 22 based on the operation information detected by the operation input detector 30 and is configured to perform various kinds of control based on the details of operation in the image forming apparatus 12.

Examples of applications stored in the ROM 20B or the HDD 26 include applications performing functions such as fax, scan, print, and copy in the present exemplary embodiment.

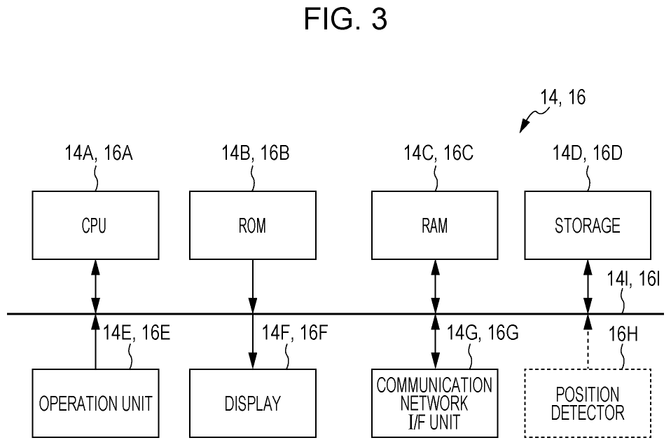

Next, description will be given with regard to a central portion of the electrical system of the client computer 14 according to the present exemplary embodiment. FIG. 3 is a block diagram depicting the central portion of the electrical system of each of the client computer 14 and the mobile terminal apparatus 16 in the information processing system 10 according to the present exemplary embodiment.

The client computer 14 according to the present exemplary embodiment includes a CPU 14A as an example of a processor, a ROM 14B, a RAM 14C, a storage 14D, an operation unit 14E, a display 14F, and a communication network interface (I/F) unit 14G, as depicted in FIG. 3. The CPU 14A is configured to manage the overall operation of the client computer 14. The ROM 14B is configured to store various control programs, various parameters, and other data in advance. The RAM 14C is a memory such as used as a work area while the CPU 14A executes various programs. The storage 14D is configured to store various kinds of data, application programs, and other data. The operation unit 14E is used to receive various kinds of information. The display 14F is used to display various kinds of information. The communication network I/F unit 14G is connected to the communication network 18 and is configured to transmit and receive various kinds of data to and from other devices connected to the communication network 18. The communication network I/F unit 14G may be configured to use various kinds of wireless communication known in the art to enable direct communication with various devices. The above components in the client computer 14 are electrically connected to each other by using a system bus 14I. Although the storage 14D is used as a storage device in the client computer 14 according to the present exemplary embodiment, examples of the storage include a nonvolatile storage device, such as an HDD or a flash memory.

The above configuration of the client computer 14 according to the present exemplary embodiment enables the CPU 14A to access the ROM 14B, the RAM 14C, and the storage 14D, acquire various kinds of data via the operation unit 14E, and display various kinds of information on the display 14F. The CPU 14A is configured to control transmission and reception of communication data via the communication network I/F unit 14G in the client computer 14.

Since the mobile terminal apparatus 16 basically has a configuration of a general-purpose computer including a CPU 16A, a ROM 16B, a RAM 16C, and other components as the client computer 14 in FIG. 3 does, detailed description will be omitted with regard to the process of sending instructions for printing from the mobile terminal apparatus 16. The mobile terminal apparatus 16 includes a position detector 16H and an image capturing unit (not depicted) such as a camera, which are not included in the client computer 14, and the position detector 16H is configured to detect the position of the mobile terminal apparatus 16 by using the technology including the global positioning system (GPS).

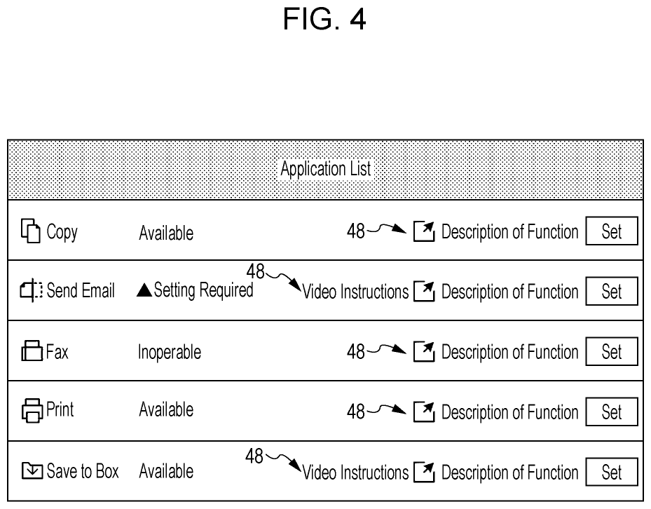

In some cases, a screen is displayed to set applications of the image forming apparatus 12, such as copy, fax, and scan, in the information processing system 10 according to the present exemplary embodiment, which is configured as described above. In such a case, for example, an application list is displayed on the screen as depicted in FIG. 4. For each application, the displayed screen includes the name and status of the application and further includes links 48 to video instructions on how to use the application and to the description of the function of the application and a setting button. FIG. 4 is an illustration depicting an example of a screen displaying an application list.

However, the links 48 to the contents including the instructions on how to use the application and the description of the function, if permanently displayed, lead to a complicated layout, resulting in a screen that is difficult to use. Further, if a user has a good grasp of an application, the display of the links 48 to the contents including the instructions on how to use the application and the description of the function are redundant, and the usability may worsen.

Thus, in the present exemplary embodiment, the type of a user who uses an application of the image forming apparatus 12 is detected, and when a selection screen for applications is displayed, based on the type of a user that has been detected, for each of the applications, whether to display or hide a link or links 48 is controlled since the link or links 48 work as an instruction section used to instruct that information regarding the function of the application be displayed.

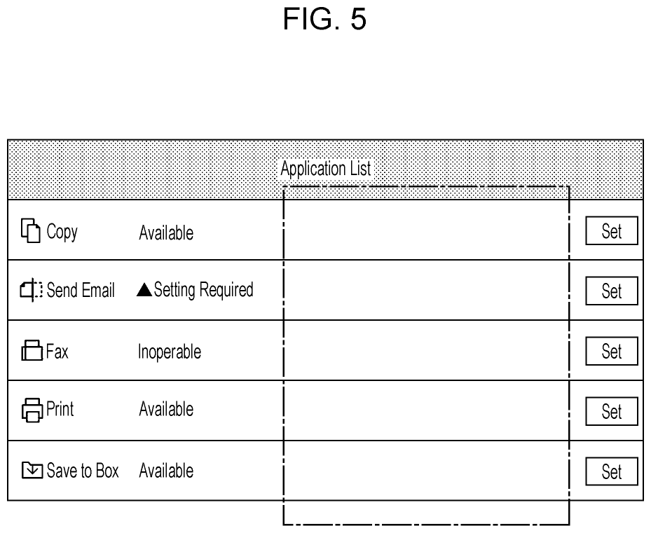

For example, if the type of a user is an authenticated machine administrator, the links 48 to the video instructions and to the description of the function are hidden as indicated by the dot-dash line in FIG. 5, and if the type of a user is an unauthenticated user, the links 48 are displayed as in FIG. 4. FIG. 5 is an illustration depicting an example of a screen displaying an application list in which, for each application, the links 48 to the video instructions on how to use the application and to the description of the function of the application are hidden.

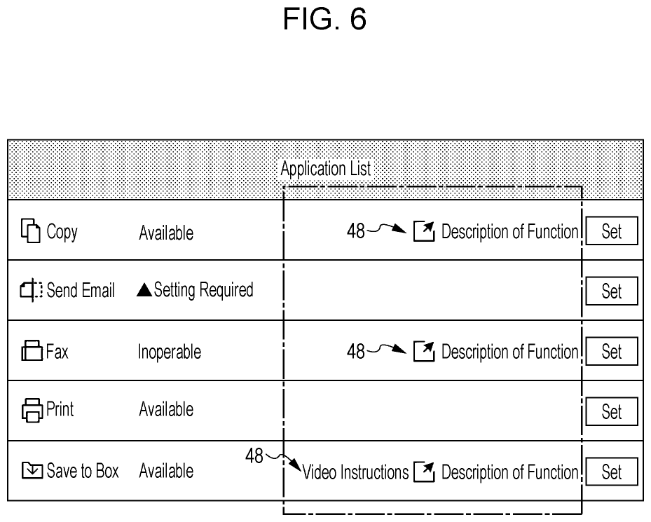

If the type of a user is an authenticated user, whether to display or hide the links 48 is controlled based on the number of times that the user has used an application. For example, if the number of times that the user has used the application “Send Email” and the number of times that the user has used the application “Print” are each equal to a predetermined threshold or more, the links 48 are hidden as indicated by the dot-dash line in FIG. 6. FIG. 6 is an illustration depicting an example of a screen displaying an application list in which, for the applications “Send Email” and “Print”, the links 48 to the video instructions on how to use the application and to the description of the function of the application are hidden.

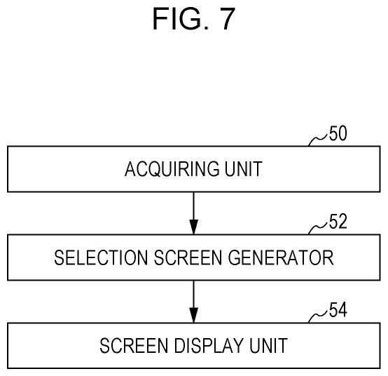

Next, description will be given with regard to the functional configuration of the control unit 20 configured to control the display of the links 48 described above in the image forming apparatus 12. FIG. 7 is a functional block diagram depicting the functional configuration of the control unit 20 of the image forming apparatus 12 according to the present exemplary embodiment.

The CPU 20A executes programs stored in the ROM 20B, so that the control unit 20 performs functions of an acquiring unit 50, a selection screen generator 52, and a screen display unit 54.

The acquiring unit 50 is configured to acquire the type of a user who uses applications performing functions including fax, scan, print, and copy. For example, the acquiring unit 50 is configured to acquire the type of a user, such as whether the user has been authenticated and what privilege the user has as an authenticated user. Examples of the type of a user include an unauthenticated user, an authenticated user, and an authenticated machine administrator. If a user needs to move to the image forming apparatus 12 to run an application, such as fax, scan, or copy, the user is authenticated, for example, by using a card. In contrast, if a user remotely operates the image forming apparatus 12 to run an application, such as print, the user is authenticated, for example, by entering information such as a user ID or a password.

The selection screen generator 52 is configured to generate a selection screen for applications. The selection screen generator 52 is also configured to, when the selection screen for applications is displayed, control whether to display or hide each link 48, which is described above, based on the type of a user acquired by the acquiring unit 50.

The screen display unit 54 is configured to perform processing for displaying the selection screen for applications, which is generated by the selection screen generator 52. For example, while the image forming apparatus 12 is operated, the screen display unit 54 causes the user interface 22 to display the selection screen. While the client computer 14 is operated, the screen display unit 54 performs processing to cause the display 14F to display the selection screen, and while the mobile terminal apparatus 16 is operated, the screen display unit 54 performs processing to cause a display 16F to display the selection screen.

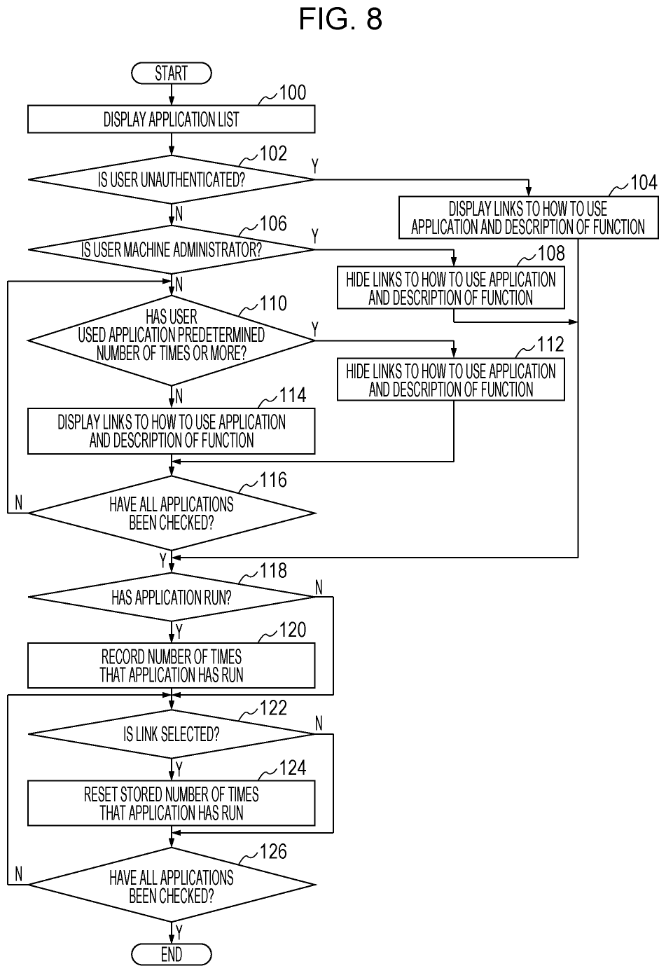

Next, description will be given with regard to a specific process performed by the image forming apparatus 12 in the information processing system 10 according to the present exemplary embodiment, which is configured as described above. FIG. 8 is a flowchart depicting an example of a process performed by the image forming apparatus 12 in the information processing system 10 according to the present exemplary embodiment. The process in FIG. 8 starts, for example, when an instruction for selecting an application is provided.

In step 100, the CPU 20A displays an application list, and the process proceeds to step 102.

In step 102, the CPU 20A determines whether the user is unauthenticated. The determination is made by the selection screen generator 52 based on the type of a user acquired by the acquiring unit 50. If an affirmative determination is made, the process proceeds to step 104, and if a negative determination is made, the process proceeds to step 106.

In step 104, the CPU 20A displays links 48 to the instructions on how to use an application and to the description of the function of the application, and the process proceeds to step 118. Specifically, the selection screen generator 52 adds to the screen the links 48 to the instructions on how to use the application and to the description of the function of the application, and the screen display unit 54 displays the selection screen for applications.

In step 106, the CPU 20A determines whether the user is a machine administrator. The determination is made by the selection screen generator 52 based on the type of a user acquired by the acquiring unit 50. If an affirmative determination is made, the process proceeds to step 108, and if a negative determination is made, the process proceeds to step 110.

In step 108, the CPU 20A hides the links 48 to the instructions on how to use the application and to the description of the function of the application, and the process proceeds to step 118. Specifically, the selection screen generator 52 removes from the screen the links 48 to the instructions on how to use the application and to the description of the function of the application, and the screen display unit 54 displays the selection screen for applications.

In step 110, the CPU 20A determines whether the authenticated user has used an application a predetermined number of times or more. If an affirmative determination is made, the process proceeds to step 112, and if a negative determination is made, the process proceeds to step 114.

In step 112, the CPU 20A hides the links 48 to the instructions on how to use the application and to the description of the function of the application, and the process proceeds to step 116. Specifically, the selection screen generator 52 removes from the screen the links 48 to the instructions on how to use the application and to the description of the function of the application, and the screen display unit 54 displays the selection screen for applications.

In step 114, the CPU 20A displays the links 48 to the instructions on how to use the application and to the description of the function of the application, and the process proceeds to step 116. Specifically, the selection screen generator 52 adds to the screen the links 48 to the instructions on how to use the application and to the description of the function of the application, and the screen display unit 54 displays the selection screen for applications.

In step 116, the CPU 20A determines whether to have checked for all the applications the number of times that an application has been used. If a negative determination is made, the process returns to step 110 and repeats the above procedure, and if an affirmative determination is made, the process proceeds to step 118.

In step 118, the CPU 20A determines whether an application has run. If an affirmative determination is made, the process proceeds to step 120, and if a negative determination is made, the process proceeds to step 122.

In step 120, the CPU 20A records the number of times that the application has run, and the process proceeds to step 122. The number of times that the application has run is recorded for each authenticated user.

In step 122, the CPU 20A determines whether the link 48 to the instructions on how to use an application or the link 48 to the description of the function of an application is selected. If an affirmative determination is made, the process proceeds to step 124, and if a negative determination is made, the process proceeds to step 126.

In step 124, the CPU 20A resets the stored number of times that the application has run, and the process proceeds to step 126.

In step 126, the CPU 20A determines whether to have checked for all the applications whether the link 48 has been selected. If a negative determination is made, the process returns to step 122 and repeats the above procedure, and if an affirmative determination is made, the process completes a series of procedures.

In the above process, a user may forget what kind of operation an application performs if the user does not use the application for a while after the links 48 to the instructions on how to use the application and to the description of the function of the application are hidden.

Thus, the links 48 to the instructions on how to use the application and to the description of the function of the application may be displayed again if the application is not used for a predetermined period. Further, the links 48 to the instructions on how to use an application and to the description of the function of an application may be displayed for all the applications if a user does not use the image forming apparatus 12 for a predetermined period.

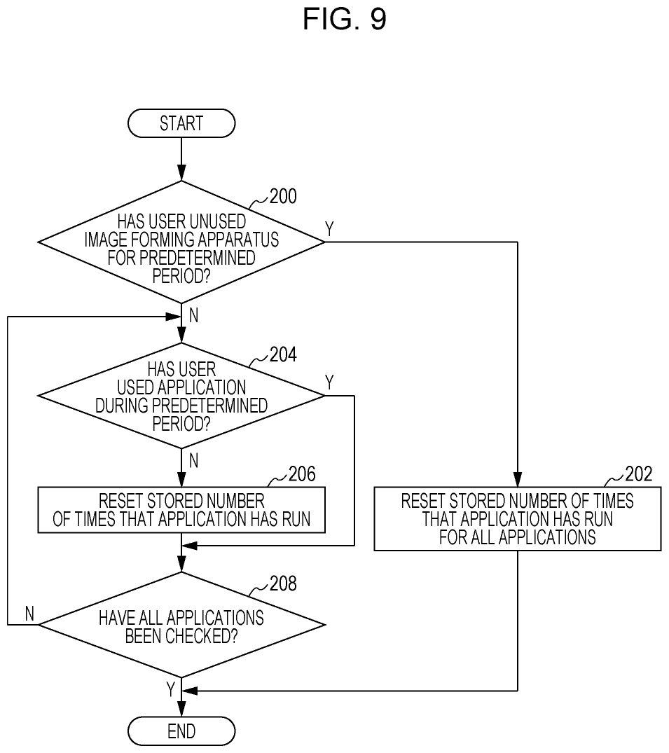

Description will be given herein with regard to the process of resuming the display of the links 48 to the instructions on how to use an application and to the description of the function of an application. FIG. 9 is a flowchart depicting an example of a process of resuming the display of the links 48 to the instructions on how to use an application and to the description of the function of an application in the image forming apparatus 12 according to the present exemplary embodiment. The process in FIG. 9 is performed, for example, between step 106 and step 110 described above.

In step 200, the CPU 20A determines whether the user has unused the image forming apparatus 12 for a predetermined period. If an affirmative determination is made, the process proceeds to step 202, and if a negative determination is made, the process proceeds to step 204.

In step 202, the CPU 20A resets the stored number of times that an application has run for all the applications and completes a series of procedures of resuming the display of the links 48.

In step 204, the CPU 20A determines whether the user has used an application during a predetermined period. If a negative determination is made, the process proceeds to step 206, and if an affirmative determination is made, the process proceeds to step 208.

In step 206, the CPU 20A resets the stored number of times that the application has run, and the process proceeds to step 208.

In step 208, the CPU 20A determines whether to have checked for all the applications whether the user has used an application during the predetermined period. If a negative determination is made, the process returns to step 204 and repeats the above procedure, and if an affirmative determination is made, the process completes a series of procedures of resuming the display of the links 48.

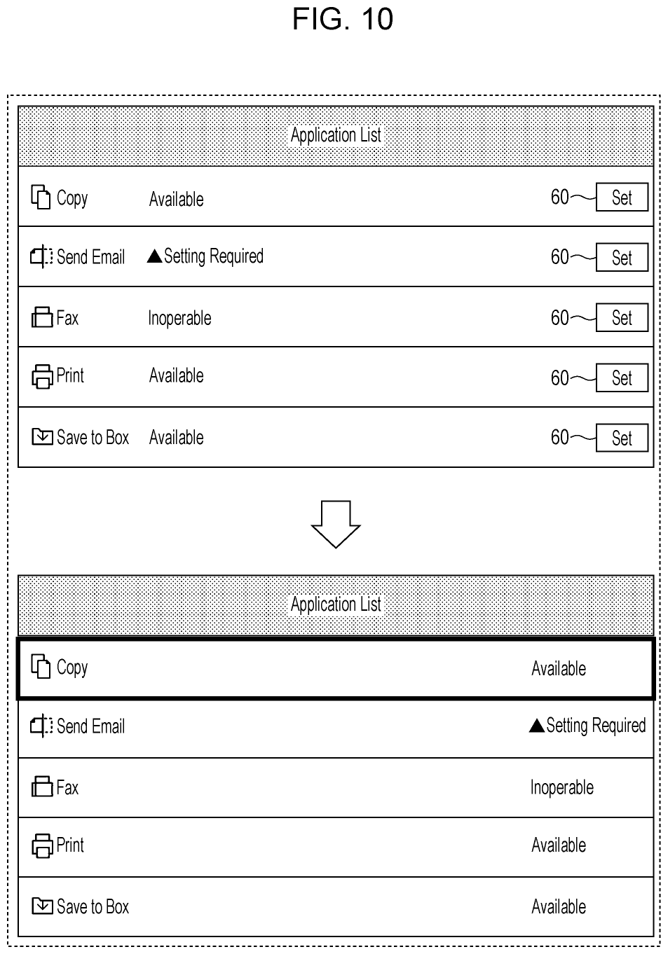

In the above exemplary embodiment, when the links 48 to the instructions on how to use an application and to the description of the function of an application are hidden, the display may be changed so that the entire row for the application can be selectable instead of the display of a setting button 60 as depicted in FIG. 10. In this case, the characters on the setting button 60 are removed, and the entire row becomes a selectable region as enclosed by the thick solid line in the lower part of FIG. 10. In this way, the selectable region is enlarged and easy to select, and the usability improves. In the example in FIG. 10, the entire row for the setting of “copy”, which is one of the selectable regions, is selected instead of the setting button.

Although the description has been given as an example with regard to the case where the image forming apparatus 12 is configured to perform the process in FIG. 8 in the above exemplary embodiment, the server 11 may be configured to perform the process in FIG. 8 if the server 11 generates the selection screen for applications. Alternatively, an application for operating the image forming apparatus 12 may be installed on the mobile terminal apparatus 16, and the mobile terminal apparatus 16 may be configured to perform the process in FIG. 8.

Although the procedures from step 100 to step 116 of displaying an application list and the procedures from step 118 to step 126 of recording the number of times that an application has run are performed at the same time as an example in the above exemplary embodiment, these procedures need not be performed at the same time.

Although the description has been given as an example with regard to the case of displaying a screen for setting applications in the above exemplary embodiment, the screen is not limited to this example, and other screens in which applications are displayed may be used.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process performed by each unit in the information processing system 10 according to the exemplary embodiment above may be a process performed by using software, a process performed by using hardware, or a process performed by using a combination of software and hardware. The process performed by each unit in the information processing system 10 may be stored in a recording medium as a program and distributed by using the recording medium.

The present disclosure is not limited to the above exemplary embodiment, and various modifications to the above exemplary embodiment may obviously be practiced as long as they do not depart from the spirit of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An information processing apparatus comprising:
a processor configured to:
   detect a type of a user who uses an application; and
   based on the type that has been detected, control whether to display or hide an instruction section for the application when a selection screen for the application is displayed, the instruction section being used to instruct that information regarding functionality of the application be displayed.
(((2))) The information processing apparatus according to (((1))), wherein the processor is configured to hide the instruction section when the type is a machine administrator.
(((3))) The information processing apparatus according to (((1))) or (((2))), wherein the processor is configured to record the number of times that the application has been used by an authenticated user and control whether to display or hide the instruction section for the application based on the number of times that the application has been used.
(((4))) The information processing apparatus according to (((3))), wherein the processor is configured to hide the instruction section when the number of times that the application has been used is equal to a predetermined value or more.
(((5))) The information processing apparatus according to (((4))), wherein the processor is configured to display the instruction section when the number of times that the application has been used is less than the predetermined value.
(((6))) The information processing apparatus according to any one of (((3))) to (((5))), wherein the processor is configured to reset the number of times that the application has been used when the instruction section is used to instruct that the information be displayed.
(((7))) The information processing apparatus according to any one of (((3))) to (((6))), wherein the processor is configured to, for an application that has been unused for a predetermined period or longer, reset the number of times that the application has been used.
(((8))) The information processing apparatus according to any one of (((3))) to (((7))), wherein the processor is configured to, for a user who has not used the information processing apparatus for a predetermined period, reset the number of times that the application has been used.
(((9))) The information processing apparatus according to any one of (((1))) to (((8))), wherein the processor is configured to display the instruction section for the application for an unauthenticated user.
(((10))) The information processing apparatus according to any one of (((1))) to (((9))), wherein the processor is configured to render an entire display area for the application selectable when the instruction section for the application is hidden.
(((11))) A program causing a computer to execute a process for information processing, the process comprising:
detecting a type of a user who uses an application; and
based on the type that has been detected, controlling whether to display or hide an instruction section for the application when a selection screen for the application is displayed, the instruction section being used to instruct that information regarding functionality of the application be displayed.

What is claimed is:

1. An information processing apparatus comprising:
a processor configured to:
detect a type of a user who uses an application; and
based on the type that has been detected, control whether to display or hide an instruction section for the application when a selection screen for the application is displayed, the instruction section being used to instruct that information regarding functionality of the application be displayed.

2. The information processing apparatus according to claim 1,
wherein the processor is configured to hide the instruction section when the type is a machine administrator.

3. The information processing apparatus according to claim 1,
wherein the processor is configured to record the number of times that the application has been used by an authenticated user and control whether to display or hide the instruction section for the application based on the number of times that the application has been used.

4. The information processing apparatus according to claim 3,
wherein the processor is configured to hide the instruction section when the number of times that the application has been used is equal to a predetermined value or more.

5. The information processing apparatus according to claim 4,
wherein the processor is configured to display the instruction section when the number of times that the application has been used is less than the predetermined value.

6. The information processing apparatus according to claim 3,
wherein the processor is configured to reset the number of times that the application has been used when the instruction section is used to instruct that the information be displayed.

7. The information processing apparatus according to claim 3,
wherein the processor is configured to, for an application that has been unused for a predetermined period or longer, reset the number of times that the application has been used.

8. The information processing apparatus according to claim 3,
wherein the processor is configured to, for a user who has not used the information processing apparatus for a predetermined period, reset the number of times that the application has been used.

9. The information processing apparatus according to claim 1,
wherein the processor is configured to display the instruction section for the application for an unauthenticated user.

10. The information processing apparatus according to claim 1,
wherein the processor is configured to render an entire display area for the application selectable when the instruction section for the application is hidden.

11. A non-transitory computer readable medium storing a program causing a computer to execute a process for information processing, the process comprising:
detecting a type of a user who uses an application; and
based on the type that has been detected, controlling whether to display or hide an instruction section for the application when a selection screen for the application is displayed, the instruction section being used to instruct that information regarding functionality of the application be displayed.

12. An information processing method comprising:
detecting a type of a user who uses an application; and
based on the type that has been detected, controlling whether to display or hide an instruction section for the application when a selection screen for the application is displayed, the instruction section being used to instruct that information regarding functionality of the application be displayed.
